(19) United States
(12) Patent Application Publication
(10) Pub. No.: US 2024/0142558 A1
(43) Pub. Date: May 2, 2024

(54) IMAGE FORMING SYSTEM

(71) Applicant: KYOCERA Document Solutions Inc., Osaka (JP)

(72) Inventors: Ryosuke KATO, Osaka (JP); Keisuke FUKUSHIMA, Osaka (JP); Shigenaka KANEMITSU, Osaka (JP); Yasushi TSUKAMOTO, Osaka (JP); Akihiko IKAZAKI, Osaka (JP)

(21) Appl. No.: 18/548,471

(22) PCT Filed: Feb. 22, 2022
(86) PCT No.: PCT/JP2022/007109

§ 371 Date: Aug. 30, 2023

(30) Foreign Application Priority Data
Mar. 4, 2021 (JP) 2021-034214

(51) Int. Cl. G01S 1/08; G01S 1/04

(52) U.S. Cl. CPC G01S 1/08; G01S 1/0428

(57) ABSTRACT

Each of plural image forming apparatuses 2-1 to 2-N transmits a beacon signal including a device ID. Each of plural user terminal apparatuses 1-1 to 1-M determines a user ID of a user 101-i who currently uses it, receives the beacon signal transmitted from an image forming apparatus 2-j, and transmits to a mapping processing apparatus mapping information that associates the user ID and the device ID in the received beacon signal. Further, the mapping processing apparatus receives the mapping information on each user, determines a user associated by the mapping information with each image forming apparatus 2-j among the plural image forming apparatuses 2-1 to 2-M, and generates map data in which the determined user is associated with each image forming apparatus 2-j.

### TECHNICAL FIELD

The present invention relates to an image forming system.

### BACKGROUND ART

In an image forming system, a mobile terminal apparatus detects an image forming apparatus located at its periphery, acquires position information of the image forming apparatus located at its periphery, and on the basis of a current position of this mobile terminal apparatus and the position information of the image forming apparatus located at its periphery, generates a map image including this mobile terminal apparatus and the image forming apparatus located at its periphery (see PATENT LITERATURE *1, for example).

### CITATION LIST

### Patent literature

PATENT LITERATURE *1: Japan Patent Application Publication No. 2015-46058.

### SUMMARY OF INVENTION

### Technical Problem

Recently a hot-desking office is installed in which fixed seats are not assigned to employees and an employee decides a work place when coming to the office and then works.

In a hot-desking office, it may be difficult to determine a current position of an employee (user) because fixed seats are not assigned to employees. In the aforementioned image forming system, a user finds out a position of an image forming apparatus located at his/her periphery using the map image, but it is difficult for a user to find out a current work place of another user.

The present invention has been conceived in view of the aforementioned problem. It is an object of the present invention to obtain an image forming system and a mapping processing program that enable to find out image forming apparatuses located at peripheries of current work places of users in an office in which it is enabled to work any places.

### Solution to Problem

An image forming system according to the present invention includes plural image forming apparatuses that comprise beacon transmitters, respectively; plural user terminal apparatuses that comprise beacon receivers, respectively; and a mapping processing apparatus. Each of the plural image forming apparatuses transmits a beacon signal including a device ID using the beacon transmitter. Each of the plural user terminal apparatuses (a) determines a user ID of a user who currently uses this user terminal apparatus, (b) receives using the beacon receiver the beacon signal transmitted from the image forming apparatus located in a predetermined peripheral area, and (c) transmits to the mapping processing apparatus mapping information that associates the user ID and the device ID in the received beacon signal. Further, the mapping processing apparatus (a) receives the mapping information on the plural users, (b) determines a user associated by the mapping information with each image forming apparatus among the plural image forming apparatuses, and (c) generates map data in which the determined user is associated with the image forming apparatus.

A mapping processing program according to the present invention causes a computer to act as a mapping processing unit that (a) receives mapping information on plural users from plural user terminal apparatuses, (b) determines a user associated by the mapping information with each image forming apparatus among plural image forming apparatuses, and (c) generates map data in which the determined user is associated with the image forming apparatus. Further, the mapping information is information that associates a device ID and a user ID where the device ID is a device ID of an image forming apparatus in a beacon signal transmitted from the image forming apparatus located in a predetermined peripheral area of a user terminal apparatus and received by a user terminal apparatus and the user ID is a user ID of a user who currently uses the user terminal apparatus.

### Advantageous Effect of Invention

By means of the present invention, obtained are an image forming system and a mapping processing program that enable to find out image forming apparatuses located at peripheries of current work places of users in an office in which it is enabled to work any places.

These and other objects, features and advantages of the present invention will become more apparent upon reading of the following detailed description along with the accompanied drawings.

### BRIEF DESCRIPTION OF DRAWINGS

FIG. 1 shows a diagram that indicates a configuration of an image forming system in an embodiment of the present invention;

FIG. 2 shows a block diagram that indicates configurations of a user terminal apparatus and an image forming apparatus shown in FIG. 1;

FIG. 3 shows a diagram that explains correction of mapping information in the image forming system shown in FIGS. 1 and 2; and

FIG. 4 shows a diagram that indicates an example of a map image based on mapping information collected in the image forming system shown in FIGS. 1 and 2.

### DESCRIPTION OF EMBODIMENTS

Hereinafter, an embodiment according to aspects of the present invention will be explained with reference to a drawing.

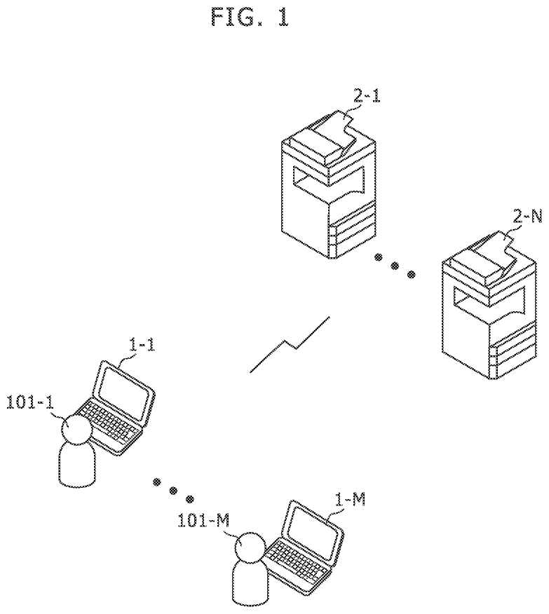

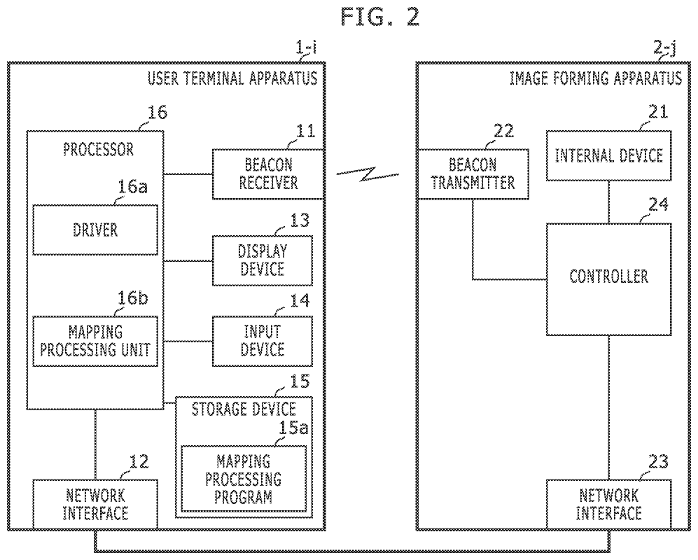

FIG. 1 shows a diagram that indicates a configuration of an image forming system in an embodiment of the present invention. FIG. 2 shows a block diagram that indicates configurations of a user terminal apparatus and an image forming apparatus shown in FIG. 1.

In the system shown in FIG. 1, plural users 101-1 to 101-M (M>1) use user terminal apparatuses 1-1 to 1-M, respectively, for example, in a hot-desking office. Further, in this system, plural image forming apparatuses 2-1 to 2-N (N>1) (such as multi function peripherals and/or printers) are installed, for example, in the hot-desking office.

A work place of each user 101-i (i=1, . . . , M) is not fixed and can be changed daily. In this system, each user terminal apparatus 1-i is, for example, a portable notebook personal computer assigned to the user 101-i. Contrarily, each image forming apparatus 2-i is not usually moved and is fixedly arranged.

Here, the user terminal apparatuses 1-1 to 1-M and the image forming apparatuses 2-1 to 2-M are connected to a network such as intranet, and are capable of data communication with each other through the network.

Each user terminal apparatus 1-includes a beacon receiver 11, a network interface 12, a display device 13, an input device 14, a storage device 15, a processor 16, and the like.

The beacon receiver 11 is a beacon receiver corresponding to beacon transmitters 22 in the image forming apparatuses 2-1 to 2-N. In other words, the beacon receiver 11 is a wireless communication device capable of receiving a beacon signal transmitted by the beacon transmitter 22 in accordance with a predetermined wireless communication standard (BLE, Bluetooth (registered trademark), or the like).

The network interface 12 is a network interface of a wireless LAN (Local Area Network) or a wired LAN, and is connected to the aforementioned network.

The display device 13 is an internal device such as a liquid crystal display, that displays an operation screen and the like for a user. The input device 14 is an internal device such as a touch panel, that detects a user operation.

The storage device 15 is a non-volatile storage device such as a flash memory or a hard disk drive, and stores data and a program such as a mapping processing program 15a.

The controller 16 is an ASIC (Application Specific Integrated Circuit) and/or a computer which includes a CPU (Central Processing Unit), a ROM (Read Only Memory), a RAM (Random Access Memory) and the like, and loads a program from the ROM or the storage device 15 to the RAM and executes it using the CPU and thereby acts as sorts of processing units.

Here, the processor 16 executes an unshown driver program and thereby acts as a driver 16a, and executes the mapping processing program 15a and thereby acts as a mapping processing unit 16b.

The driver 16a is a driver for the image forming apparatus 2-j (j=1, . . . , N), and transmits a job request to the image forming apparatus 2-j using the network interface 12 and causes the image forming apparatus 2-j to perform a job specified by the job request.

The mapping processing unit 16b has a parent-device function and a child-device function.

The child-device function (a) determines a user ID of a user 101-who currently uses the user terminal apparatus 1-i, (b) receives using the beacon receiver 11 the beacon signal transmitted from the image forming apparatus 2-j located in a predetermined peripheral area, and (c) transmits to a mapping processing apparatus mapping information that associates the user ID and the device ID in the received beacon signal.

The parent-device function (a) receives the mapping information on the plural users 101-1 to 101-M, (b) determines a user associated by the mapping information on the plural users 101-1 to 101-M with each image forming apparatus 2-j among the plural image forming apparatuses 2-1 to 2-M, and (c) generates map data in which the determined user is associated with each image forming apparatus 2-j.

In this embodiment, one of the user terminal apparatuses 1-1 to 1-M performs the parent-device function and acts as the mapping processing apparatus. It should be noted that the one of the image forming apparatuses 2-1 to 2-N may be the mapping processing apparatus or a server other than the user terminal apparatuses 1-1 to 1-M and the one of the image forming apparatuses 2-1 to 2-N may be the mapping processing apparatus.

Further, in each user terminal apparatus 1-i, the mapping processing unit 16b (a) acquires the map data from the mapping processing apparatus using the network interface 12, (b) on the basis of the map data, determines an image forming apparatus 2-j of a device ID associated with the user ID of the user 101-who currently uses this user terminal apparatus 1-i, and (c) sets to the driver 16a the determined image forming apparatus 2-j as a destination of a print job request and transmits the print job request to the image forming apparatus 2-j using the driver 16a.

Further, in each user terminal apparatus 1-i, the mapping processing unit 16b generates a map image based on the acquired map data and displays the map image on the display device 13.

In this process, the map image may include an icon image of the image forming apparatus 2-j at a position corresponding to an installation position of the image forming apparatus 2-j and an icon image of the user 1-associated with the icon of the image forming apparatus 2-j. Specifically, in this case, the image forming apparatus 2-j is indicated in the map image with a positional relationship corresponding to a positional relationship of the installation position of the image forming apparatus 2-j, and a user can easily understand visually which of the users is at a periphery of which of the image forming apparatuses 2-j.

Meanwhile, an unshown resource management server (Active Directory server or the like) may manage using a database user registration data that associates a user ID and property information such as user name with each other for each user 101-i, and device registration data that associates a device ID and property information such as device name with each other for each image forming apparatus 2-j; and may provide the property information such as the user name or the device name corresponding to the user ID or the device ID. Further, in this case, the map image may indicate the property information such as the user ID or the device ID with the icon image. Furthermore, the resource management server may manage the position information of the installation position of each image forming apparatus 2-j as the aforementioned property information. Furthermore, the device property information of each image forming apparatus 2-j may be not managed by the resource management server, but each image forming apparatus 2-j may manage its own device property information as a management information base and may be capable of providing it using SNMP (Simple Network Management Protocol).

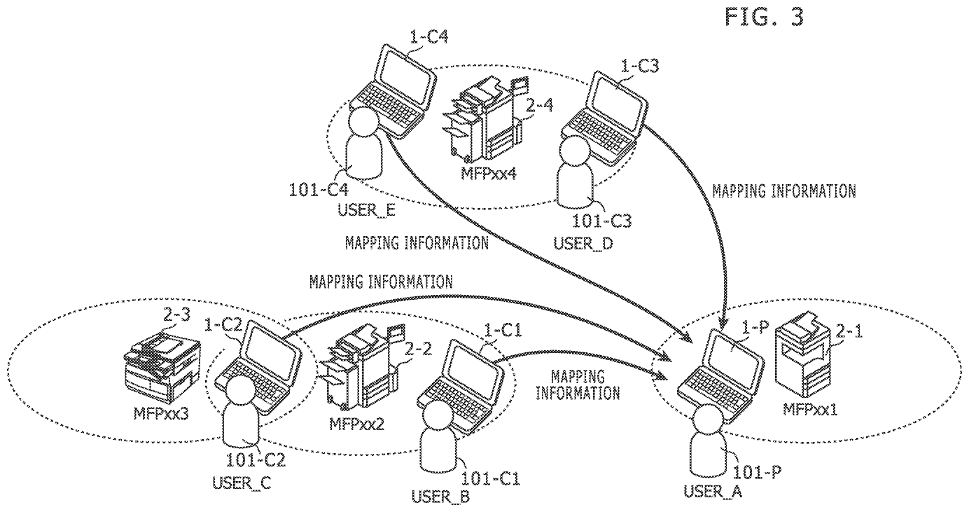

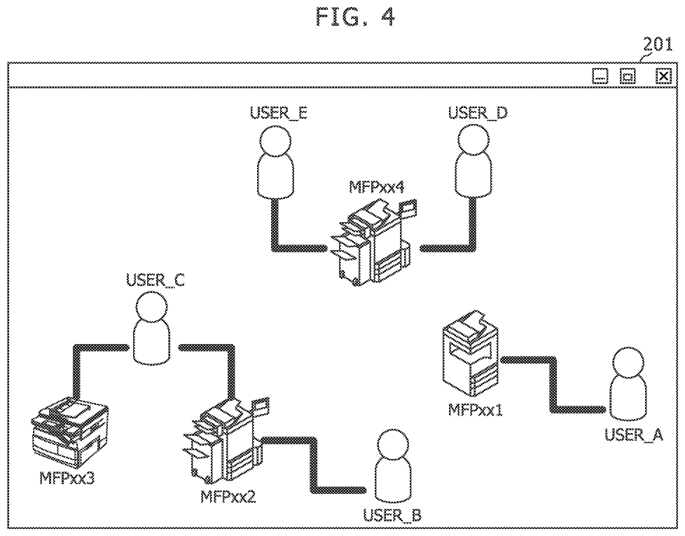

FIG. 3 shows a diagram that explains correction of mapping information in the image forming system shown in FIGS. 1 and 2. FIG. 4 shows a diagram that indicates an example of a map image based on mapping information collected in the image forming system shown in FIGS. 1 and 2.

For example, as shown in FIG. 3, in a peripheral area (receivable area of the beacon signal) of the image forming apparatus 2-1 named “MFPxx1”, the user terminal apparatus 1-P of the user 101-P of user name “USER_A” is arranged; in a peripheral area of the image forming apparatus 2-2 named “MFPxx2”, the user terminal apparatus 1-C1 of the user 101-C1 of user name “USER_B” and the user terminal apparatus 1-C2 of the user 101-C2 of user name “USER_C” are arranged; in a peripheral area of the image forming apparatus 2-3 named “MFPxx3”, the user terminal apparatus 1-C2 of the user 101-C2 of user name “USER_C” is arranged; in a peripheral area of the image forming apparatus 2-4 named “MFPxx4”, and the user terminal apparatus 1-C3 of the user 101-C3 of user name “USER_D” and the user terminal apparatus 1-C4 of the user 101-C4 of user name “USER_E” are arranged; and in this case, if the user terminal apparatus 1-P is specified as the mapping processing apparatus, then the mapping information is generated as follows.

The user terminal apparatus 1-P generates as its own mapping information mapping information that associates the user ID of the user 101-P and the device ID of the image forming apparatus 2-1. The user terminal apparatus 1-C1 generates mapping information that associates the user ID of the user 101-C1 and the device ID of the image forming apparatus 2-2, and transmits the generated mapping information to the user terminal apparatus 1-P. The user terminal apparatus 1-C2 generates mapping information that associates the user ID of the user 101-C2 and the device ID of the image forming apparatus 2-2 and mapping information that associates the user ID of the user 101-C2 and the device ID of the image forming apparatus 2-3, and transmits the generated mapping information to the user terminal apparatus 1-P. The user terminal apparatus 1-C3 generates mapping information that associates the user ID of the user 101-C3 and the device ID of the image forming apparatus 2-4, and transmits the generated mapping information to the user terminal apparatus 1-P. The user terminal apparatus 1-C4 generates mapping information that associates the user ID of the user 101-C4 and the device ID of the image forming apparatus 2-4, and transmits the generated mapping information to the user terminal apparatus 1-P.

In a case of the situation shown in FIG. 3, for example, the map image 201 as shown in FIG. 4 is generated and displayed. When generating and displaying, as mentioned, the user name and the device name corresponding to the user ID and the device ID are determined, and in the map image 201, the corresponding user names and device names are displayed with icons that indicate each image forming apparatus 2-j and each user 101-i.

Consequently, a user can determine where each user is, on the basis of each image forming apparatus 2-j as reference point, and can find out a current position of a desired user.

Further, in FIG. 2, the image forming apparatus 2-j includes an internal device 21 such as printing device, a beacon transmitter 22, a network interface 23, and a controller 24.

If the internal device 21 is a printing device, the internal device 21 is an internal device that prints an image based on print image data specified by a print job request on a print paper sheet (in accordance with an electrophotographic manner, for example).

The beacon transmitter 22 is an internal device that performs data communication in accordance with a predetermined near field wireless communication standard such as Bluetooth (registered trademark), and transmits a beacon signal including a device ID unique to this image forming apparatus 2-j, for example, in accordance with BLE (Bluetooth Low Energy).

The network interface 23 is a network interface for a wireless LAN, a wired LAN or the like, and is an internal device that is connected to the aforementioned network and performs data communication with another apparatus (the user terminal apparatus 1-or the like) through the network.

The controller 24 includes a computer, an ASIC (Application Specific Integrated Circuit) and/or the like, receives a job request, and performs a job specified by the job request using the internal device 21. For example, upon receiving the print job request, the controller 24 performs a print job specified by the print job request using a printing device as the internal device 21 and outputs a print product.

Further, the controller 24 controls the beacon transmitter 22 and causes the beacon transmitter 22 to repeatedly transmit the beacon signal including the device ID unique to this image forming apparatus 2-j with a predetermined transmission strength (e.g. −30 dBm of radio wave strength at a position 2 meters away) and a predetermined transmission frequency (e.g. once every 30 seconds, once every 1 minute, once every 5 minutes, or the like). This transmission strength and the transmission frequency are set by editable setting values. Since the size of the peripheral area depends on the transmission strength, the transmission strength and therefore the size of the peripheral area may be set correspondingly to the number N of the image forming apparatuses 2-1 to 2-N, an average distance or a maximum distance between two apparatuses adjacent to each other among image forming apparatuses 2-1 to 2-N, and/or the like.

The following part explains a behavior of the aforementioned image forming system.

### (a) Collection of Mapping Information

Before starting work, each user 101-operates the user terminal apparatus 1-i, inputs his/her own user ID, and logs in. The mapping processing unit 16b of this user terminal apparatus 1-determines that this user ID is a user ID of a user who currently uses this user terminal apparatus 1-i.

Subsequently, the mapping processing unit 16b determines whether a beacon signal transmitted from an image forming apparatus 2-j is received by the beacon receiver 11 or not, and if the beacon signal is received, then determines a device ID included in this beacon signal.

If the device ID of the image forming apparatus 2-j in a peripheral area is determined, then the mapping processing unit 16b transmits mapping information that associates this device ID and the aforementioned user ID with each other, to a mapping processing apparatus (here, the user terminal apparatus 1-P) using the network interface 12.

The mapping processing unit 16b of the user terminal apparatus 1-P receives the mapping information and upon receiving it, stores it into an unshown nonvolatile storage device. Here, if mapping information on the user ID included in the received mapping information has been stored, then the stored mapping information is updated with the received mapping information.

### (b) Generation of Map Data

If a user 101-wants to display a map image, acquires map data for setting a destination of transmission of a print job request, or the like, the user 101-performs a predetermined user operation to the user terminal apparatus 1-i. Upon detection of this user operation by the input device 14, the mapping processing unit 16b of the user terminal apparatus 1-transmits a mapping-data transmission request to the mapping processing apparatus (here, the user terminal apparatus 1-P) using the network interface 12.

The mapping processing unit 16b of the user terminal apparatus 1-P receives the mapping-data transmission request using the network interface 23, and upon receiving it, merges mapping information currently stored in the aforementioned storage device and thereby generates mapping data (a list of a user 101-(his/her user ID) associated with each image forming apparatus 2-j (its device ID) among the image forming apparatuses 201 to 2-N), and transmits the mapping data to the user terminal apparatus 1-using the network interface 23.

The mapping processing unit 16b of the user terminal apparatus 1-receives the mapping data, and upon receiving it, on the basis of the mapping data, (a) determines an image forming apparatus 2-j of device ID associated with the user ID of this user 101-and sets the determined image forming apparatus 2-j as a destination of transmission of a print job request, and (b) if needed, generates a map image as shown in FIG. 4, for example, and displays the map image on the display device 13.

As mentioned, in the aforementioned embodiment, each of the plural image forming apparatuses 2-1 to 2-N transmits a beacon signal including a device ID using the beacon transmitter 22. Each of the plural user terminal apparatuses 1-1 to 1-M (a) determines a user ID of a user 101-who currently uses the user terminal apparatus 1-i, (b) receives using the beacon receiver 11 the beacon signal transmitted from the image forming apparatus 2-j located in a predetermined peripheral area, and (c) transmits to a mapping processing apparatus mapping information that associates the user ID and the device ID in the received beacon signal. Further, the mapping processing apparatus (a) receives the mapping information on the plural users 101-1 to 101-M, (b) determines a user associated by the mapping information on the plural users 101-1 to 101-M with each image forming apparatus 2-j among the plural image forming apparatuses 2-1 to 2-M, and (c) generates map data in which the determined user is associated with each image forming apparatus 2-j.

Consequently, it is enabled to find out image forming apparatuses 2-j located at peripheries of current work places of users in an office in which it is enabled to work any places. Therefore, a user terminal apparatus 1-is enabled to determine an image forming apparatus 2-j located in a periphery of its user, and a user can determine an approximate current position of another user (i.e. another user is in a periphery of which image forming apparatus 2-J).

Further, it should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

### INDUSTRIAL APPLICABILITY

For example, the present invention is applicable to an image forming system.

1. An image forming system, comprising:
plural image forming apparatuses that comprise beacon transmitters, respectively;
plural user terminal apparatuses that comprise beacon receivers, respectively; and
a mapping processing apparatus;
wherein each of the plural image forming apparatuses transmits a beacon signal including a device ID using the beacon transmitter;
each of the plural user terminal apparatuses (a) determines a user ID of a user who currently uses this user terminal apparatus, (b) receives using the beacon receiver the beacon signal transmitted from the image forming apparatus located in a predetermined peripheral area, and (c) transmits to the mapping processing apparatus mapping information that associates the user ID and the device ID in the received beacon signal; and
the mapping processing apparatus (a) receives the mapping information on the plural users, (b) determines a user associated by the mapping information with each image forming apparatus among the plural image forming apparatuses, and (c) generates map data in which the determined user is associated with the image forming apparatus.

2. The image forming system according to claim 1, wherein each of the plural user terminal apparatuses (a) acquires the map data, (b) determines the image forming apparatus of the device ID associated with the user ID of the user who currently uses this user terminal apparatus, and (c) transmits a print job request to the determined image forming apparatus; and
upon receiving the print job request, the image forming apparatus performs a print job specified by the print job request and outputs a print product.

3. The image forming system according to claim 1, wherein each of the plural user terminal apparatuses (a) acquires the map data, and (b) displays a map image based on the map data.

4. The image forming system according to claim 3, wherein the map image includes an icon image of the image forming apparatus at a position corresponding to an installation position of this image forming apparatus.

5. The image forming system according to claim 1, wherein the mapping processing apparatus is one of plural user terminal apparatuses.
